(19) United States
(12) Patent Application Publication
(10) Pub. No.: US 2024/0336145 A1
(43) Pub. Date: Oct. 10, 2024

(54) MECHANICAL HAUL TRUCK HYBRID SYSTEM

(71) Applicant: FLANDERS ELECTRIC MOTOR SERVICE, LLC, Evansville, IN (US)

(72) Inventors: Brian Curtis HAVENS, Columbia, SC (US); Michael Gordon ONSAGER, Franklin, WI (US)

(73) Assignee: FLANDERS ELECTRIC MOTOR SERVICE, LLC, Evansville, IN (US)

(21) Appl. No.: 18/626,222

(22) Filed: Apr. 3, 2024

Related U.S. Application Data
(60) Provisional application No. 63/494,229, filed on Apr. 4, 2023.
(60) Provisional application No. 63/494,230, filed on Apr. 4, 2023.

(51) Int. Cl. B60L 7/18; B60K 1/00

(52) U.S. Cl. CPC B60L 7/18; B60K 1/00

(57) ABSTRACT

A vehicle including a chassis and an engine connected to the chassis. The vehicle also includes a torque converter directly connected to the engine. The vehicle also includes a motor having a first side and a second side directly connected to the torque converter, opposite the engine. The motor further includes a rotor having an annular shaft cavity. The motor further includes a first diameter equal to or smaller than a second diameter of the torque converter. The motor is connected to the torque converter via the annular shaft cavity. The vehicle also includes a drive shaft directly connected to the motor, opposite the torque converter. The drive shaft is operatively disposed in the annular shaft cavity. The vehicle also includes a transmission connected to drive shaft. The vehicle also includes a differential connected to the transmission. The vehicle also includes wheels connected to the differential.

### CROSS-REFERENCE TO RELATED APPLICATIONS

This application claims priority to U.S. Provisional Patent Application No. 63/494,229, filed Apr. 4, 2023, and to U.S. Provisional Patent Application No. 63/494,230, filed Apr. 4, 2023, the entireties of which are hereby incorporated by reference.

### BACKGROUND

Haul trucks are large vehicles that carry heavy loads. Haul trucks may be used during large-scale mining or construction operations. Operations that use haul trucks may have fleets of various types of haul trucks that operate around the clock. Thus, during operations, an operator may be continually servicing different haul trucks of various makes, models, and design specifications.

Haul trucks may consume an undesirable amount of fuel and produce an undesirable amount of emissions in the form of carbon dioxide, greenhouse gas, and other emissions. Therefore, it is desirable to reduce the amount of fuel consumed by a haul truck, and to reduce in other ways the haul truck's greenhouse gas emissions.

### SUMMARY

One or more embodiments provide for a vehicle. The vehicle includes a chassis and an engine connected to the chassis. The vehicle also includes a torque converter directly connected to the engine. The vehicle also includes a motor having a first side and a second side directly connected to the torque converter, opposite the engine. The motor further includes a rotor having an annular shaft cavity. The motor further includes a first diameter equal to or smaller than a second diameter of the torque converter. The motor is connected to the torque converter via the annular shaft cavity. The vehicle also includes a drive shaft directly connected to the motor, opposite the torque converter. The drive shaft is operatively disposed in the annular shaft cavity. The vehicle also includes a transmission connected to drive shaft. The vehicle also includes a differential connected to the transmission. The vehicle also includes wheels connected to the differential.

One or more embodiments provide for another vehicle. The vehicle includes a chassis and an engine connected to the chassis. The vehicle also includes a torque converter directly connected to the engine. The vehicle also includes a drive shaft directly connected to the torque converter. The vehicle also includes a motor connected to the drive shaft, opposite the torque converter. The motor further includes a rotor having an annular shaft cavity. The motor further includes a first diameter equal to or smaller than a second diameter of the torque converter. The motor is connected to the drive shaft via the annular shaft cavity. The vehicle also includes a transmission connected to motor. The vehicle also includes a differential connected to the transmission. The vehicle also includes wheels connected to the differential.

One or more embodiments provide for a method of retrofitting a haul truck including a chassis, an engine connected to the chassis, a torque converter connected to the engine, a drive shaft directly connected to the torque converter, a transmission directly connected to the drive shaft, a differential connected to the transmission, and wheels connected to the differential. The method includes decoupling the drive shaft from the torque converter. The method also includes removing a length of the drive shaft to form a shortened drive shaft. The method also includes connecting a motor directly to the torque converter or directly to the transmission. The method also includes connecting the shortened drive shaft to the motor such that the torque converter is reconnected to the transmission via the motor and the shortened drive shaft.

One or more embodiments also provide for a method of operating a haul truck including an engine. The method includes energizing a drive system and the motor of the haul truck. The method also includes modifying, by a torque converter connected to the engine and directly connected to the motor, a torque applied by an engine to the torque converter to generate a modified torque. The method also includes applying, by the torque converter, the modified torque to the motor. The method also includes turning, by the modified torque, a rotor of the motor. The method also includes turning, with the rotor, a drive shaft connected to the rotor. The method also includes turning, with the drive shaft, a transmission of the haul truck. The method also includes turning, with the transmission, a differential of the haul truck. The method also includes propelling, with the differential, wheels of the haul truck.

Other aspects of one or more embodiments will be apparent from the following description and the appended claims.

### BRIEF DESCRIPTION OF DRAWINGS

FIG. 1 shows a haul truck, in accordance with one or more embodiments.

FIG. 2 shows a block diagram of a haul truck modified into a hybrid haul truck, in accordance with one or more embodiments.

FIG. 3, FIG. 4, FIG. 5, and FIG. 6 show different views of the haul truck shown in FIG. 1, in accordance with one or more embodiments.

FIG. 7 and FIG. 8 show different views of the motor installed in the haul truck of FIG. 2 or in the haul truck as shown in the views of FIG. 3, FIG. 4, and FIG. 6, in accordance with one or more embodiments.

FIG. 9 shows a power cabinet for use in the hybrid haul truck shown in FIG. 2 through FIG. 6, in accordance with one or more embodiments.

FIG. 10 shows a flowchart for power management while operating a hybrid haul truck, in accordance with one or more embodiments.

FIG. 11 shows a flowchart of a method for retrofitting a haul truck, in accordance with one or more embodiments.

Like elements in the various figures are denoted by like reference numerals for consistency.

### DETAILED DESCRIPTION

In general, embodiments are directed to a hybrid haul truck that combines both a combustion engine and a motor as a drive system for the haul truck. One or more embodiments also include methods and devices for retrofitting many different types of haul trucks to operate as hybrid haul trucks.

Because haul trucks are very expensive (millions of dollars for each haul truck), replacing a fleet of traditional combustion engine haul trucks with a fleet of new hybrid engine haul trucks may be prohibitively expensive. However, retrofitting an existing combustion engine haul truck to use a hybrid or all-electric drive system has not been practical or cost effective.

Retrofitting has not been practical because the unique design of haul trucks (long drive shafts (relative to automobiles), different locations of the drive shaft and the transmission (relative to smaller trucks), etc.) present technical challenges to retrofitting. Additional technical challenges to retrofitting exist. For example, haul trucks are subjected to extreme conditions, in terms of the forces applied in a haul truck, the electrical currents used in a hybrid or electric haul truck, and the environmental wear imposed in harsh mining or construction conditions. In a specific example, haul trucks can carry loads in excess of 240 tons and may operate exclusively off highway in harsh conditions at low speeds, presenting conditions that may exceed the limits and capabilities of conventional motors.

For these reasons, existing combustion-driven haul trucks remain in operation and conversion to hybrid or electric haul trucks has been non-existent. However, there is a growing desire in the industry to reduce carbon emissions, in turn creating a desire to seek solutions to retrofit combustion-driven haul trucks into hybrid or electric haul trucks.

One or more embodiments address the technical challenges involved in retrofitting, in a cost effective manner, a haul truck to use a hybrid drive system. One or more embodiments provide for a single base drive system and modular power system that can be placed on an entire fleet of existing mixed haul truck models. The motor and drive system are specifically designed to handle the large amount of torque that the haul truck drivetrain uses to carry large loads while also being small enough to fit in the available space.

Due to the driveline architecture of mechanical haul trucks, an electric motor of one or more embodiments can be placed inline with the driveshaft to provide a torque assist to the engine. The motor is mounted directly to the torque converter on the engine side of the driveshaft, or is mounted directly to the transmission on the differential side of the driveshaft. The driveshaft is shortened to accommodate the space taken up by the motor. This arrangement allows for a solution without more disruptive mechanical or operational changes to the haul truck.

The motor is powered by a drive system and battery. The battery is charged by regenerative braking when the haul truck is going downhill or stopping. Supplemental charging using an external power source is available if the terrain where the haul truck is operating does not have enough downhill slope to charge the battery adequately.

The haul trucks of one or more embodiments address the challenges described above. For example, the haul trucks of one or more embodiments have an electrical system designed (as described below) to handle much higher voltages and current than are used in other common hybrid applications. The components of one or more embodiments are also designed to minimize the structural changes applied to a haul truck when retrofitting an existing haul truck.

One or more embodiments allow the motor to offset some of the load from the engine while maintaining stock performance. One or more embodiments may use the motor to vary the load on the engine to optimize the efficiency of engine operation. One or more embodiments may use the motor to increase performance of the haul truck by outputting more power than the engine can alone. One or more embodiments may use the motor to allow the engine to be completely shut off while the haul truck still operates. Thus, one or more embodiments reduce fuel consumption and reduce carbon emissions by reducing the amount of time the engine is operational, while still optimizing the engine efficiency.

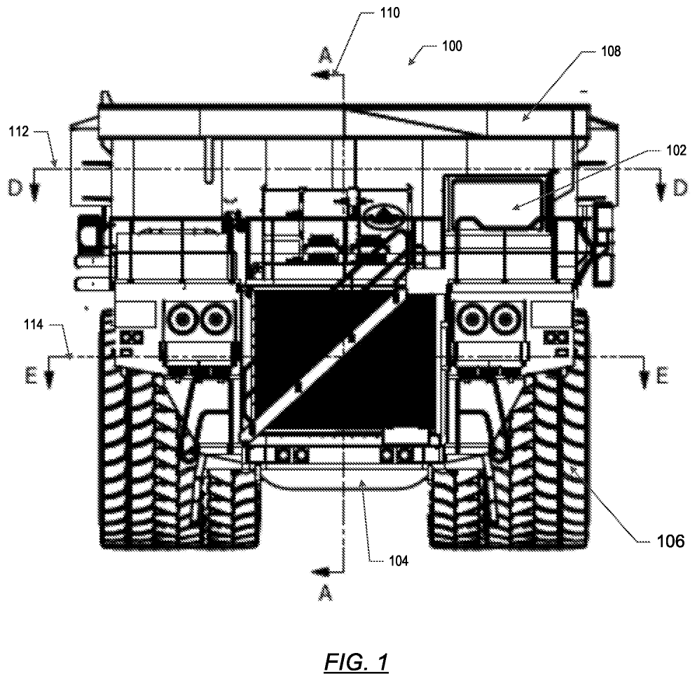

Attention is now turned to the figures. FIG. 1 shows a haul truck (100), in accordance with one or more embodiments. The haul truck (100) includes a cabin (102) in which a human operator may be present while operating the haul truck (100).

The haul truck (100) has a chassis (104), which forms the frame of the haul truck (100). The chassis (104) may include more components than just the portion of the chassis (104) shown in FIG. 1.

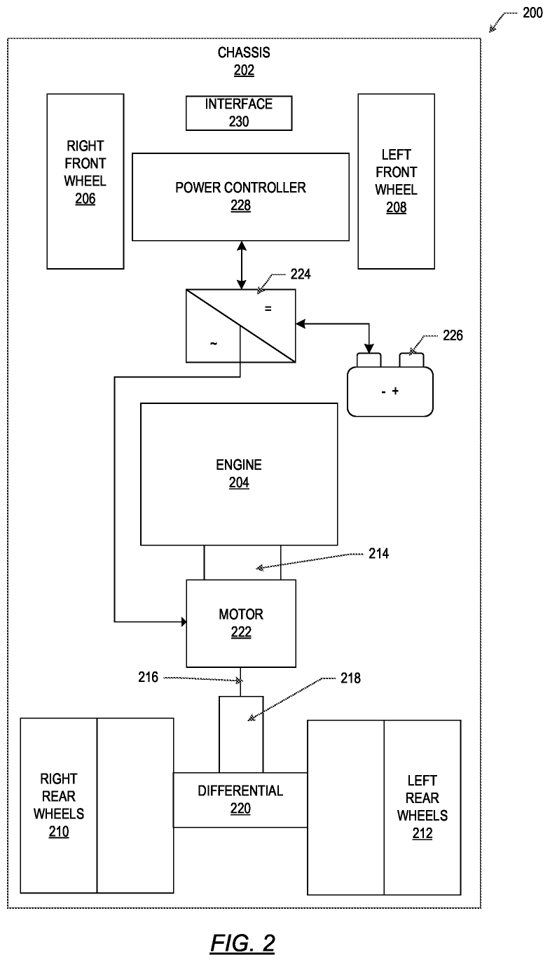

The haul truck (100) also includes a number of wheels, such as wheel (106). The wheels are driven by the drive system of the haul truck, as described with respect to FIG. 2 through FIG. 6. The haul truck (100) also includes a bed (108) for hauling loads such as dirt, sand, rocks, metals, and other types of materials.

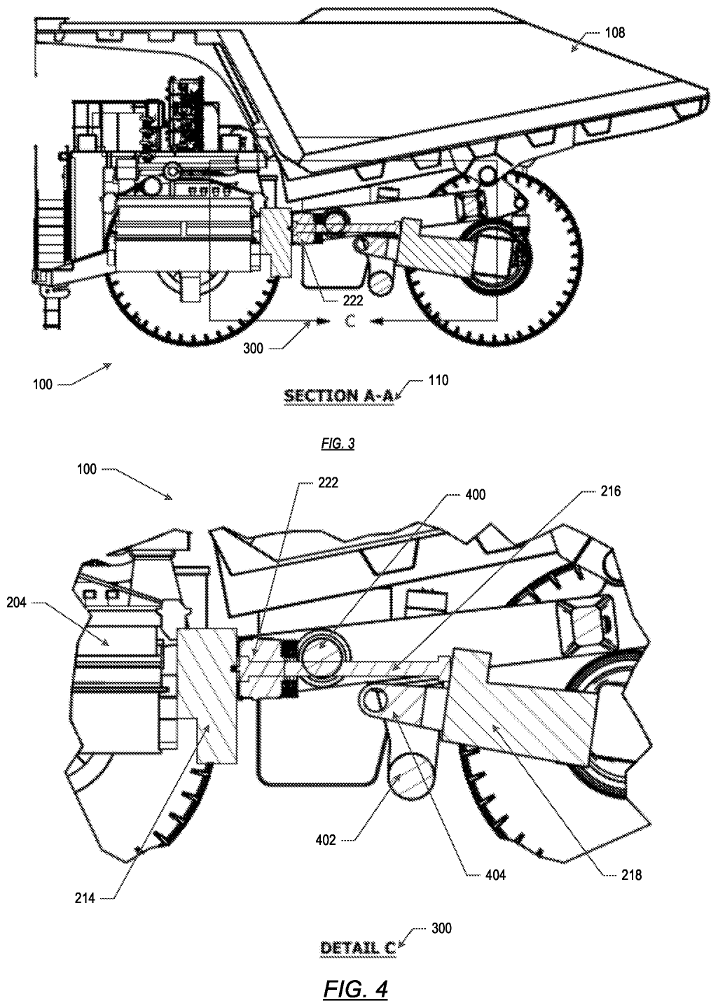

FIG. 4 shows several cutaway lines for referencing the views shown in FIG. 3 through FIG. 6. Thus, for example, line A-A (110) shows the location of a cutaway line for section A-A in FIG. 3. Similarly, line D-D (112) shows the location of a cutaway line for section D-D in FIG. 5. Likewise, line E-E (114) shows the location of a cutaway line for section E-E in FIG. 6.

FIG. 2 shows a block diagram of a haul truck modified into a hybrid haul truck, in accordance with one or more embodiments. The haul truck (200) may be a block representation of the haul truck (100) shown in FIG. 1.

The haul truck (200) includes a chassis (202) which forms a frame for the haul truck (200). Thus, the chassis (202) may include many different components connected directly or indirectly to each other, including panels, cross-beams, grills, connectors, etc. Some of the components of the chassis (202) are shown in FIG. 1 and FIG. 3 through FIG. 6. However, in general, one or more embodiments contemplate avoiding modifying the chassis (202) to the extent possible during a hybrid retrofit procedure. Nevertheless, modifications to the chassis (202) may be made when retrofitting certain models of haul trucks to a hybrid technology.

The haul truck (200) also includes an engine (204) connected to the chassis (202). The engine (204) may be one or more internal combustion engines, such as one or more diesel engines.

The haul truck (200) also includes wheels connected to the chassis (202), connected (indirectly) to the engine (204) via the motor (222), and other intervening components. Haul trucks generally include four or more wheels. In the example of FIG. 2, the haul truck (200) includes right front wheel (206), left front wheel (208), right rear wheels (210) (two wheels operating in tandem), and left rear wheels (212) (two wheels operating in tandem).

The haul truck (200) also includes a torque converter (214). The torque converter (214) is a device, usually implemented as a type of fluid coupling, that transfers rotating power from a prime mover, like the internal combustion engine (204), to a rotating driven load. In unmodified haul trucks, the torque converter (214) is connected directly to the drive shaft (216). However, as explained below, in one or more embodiments the drive shaft (216) is directly connected to the torque converter (214) or to the engine (204) on the side of the engine (204) on which the torque converter (214) is connected.

The drive shaft (216) is connected to a transmission (218). The transmission (218) is a set of gears and other components that transforms the speed or direction of a machine. The transmission (218) may adjust the gear ratio between the engine and differential so that engine stays in a narrow speed range regardless of the final vehicle speed.

The transmission (218) is connected to a differential (220). The differential (220) is a set of gears and other components that transmits rotational energy from the transmission (218) to the wheels. The differential (220) may allow the wheels to rotate at different speeds on turns. For example, the drive shaft (216) may rotate about an axis parallel to a length of the drive shaft (216). The differential changes the rotational direction of the drive shaft (216) into a rotational direction perpendicular to the length of the drive shaft (216). In this manner, the direction of rotation in the differential (220) may be perpendicular to the length of the drive shaft (216).

The haul truck (200) also includes a motor (222), which may be installed in the haul truck (200) during a retrofit process, as explained below. The motor (222) is directly connected the torque converter (214) or to the engine (204) on the side of the engine (204) to which the torque converter (214) is connected. The motor (222) is then connected to the drive shaft (216), which in turn connects to the transmission (218), the differential (220), and the rear wheels. Position of the motor (222) may vary, as described further below.

A useful design aspect of the placement of the motor (222) is that the motor is secured during high impact and high vibration operations while the haul truck (200) is in use. Furthermore, the motor (222) fits within an existing space near the torque converter (214), and accordingly may be sized and dimensioned to be approximately equal to or less than corresponding dimensions of the engine (204). The motor (222) is designed for use with the haul truck (200), and in particular is designed to be installed into an existing haul truck with a combustion engine drive system (i.e., an existing haul truck having an engine directly connected to a drive shaft, which is directly connected to a transmission, which is directly connected to a differential, which is directly connected to the wheels).

The motor (222) may be an alternating current (AC) motor that provides a minimum of 400 kilowatts (KW) of continuous electrical energy. The motor (222) may also provide 800 kW at peak power at a rotational speed of 1800 revolutions per minute (RPM) to reach desired fuel savings.

In addition, the motor (222) may be sealed to prevent the ingress of liquid, dust, and other contaminants. The undercarriage of a haul truck is a dirty environment with mud, rocks, and debris thrown up and stuck to the surfaces of the undercarriage. Thus, sealing features may be provided to prevent debris from entering the internal parts of the motor (222).

The motor (222) is connected to an inverter (224). The inverter (224) is an electronic device or circuitry that changes a direct current (DC) to alternating current (AC). The AC current may be a form of electrical current that is used to control the speed and torque of the motor (222).

The inverter (224) may operate in a voltage range from under 1000 volts (V) to over 2600V and current from under 1000 amps (A) to over 4000A. The inverter (224) may be used with different engines, traction motors, and alternators while also fitting in the space available on the deck of the haul truck (200).

Specifically, the inverter (224) may include a cluster of four liquid cooled power electronic devices. Three devices may be used as phase legs of the inverter (224) and the fourth device may be used as a braking chopper or DC/DC converter. This cluster may be supported by a laminated AC and DC bus design that allows stacking multiple clusters together to form a system.

The clusters may be combined in parallel to increase the total maximum current with each set of parallel clusters. The clusters also may be combined in series to increase the total maximum voltage with each set of series clusters. Such an arrangement allows for compatibility with different motors and alternators that are designed for different voltages and currents. Thus, for example, the inverter (224) may be customized to match an old haul truck's engineering specifications, and potentially multiple generations of engineering specifications of many different haul trucks.

The inverter (224) may be composed of multiple inverters in the form of inverter clusters. Each inverter cluster may be isolated from another inverter cluster to allow each inverter cluster to operate independently in the event one or more of the inverters fail to function within pre-determined engineering specifications. This arrangement allows a diesel-electric haul truck to still move slow in the event of an inverter or the motor failing to function within pre-determined engineering specifications.

The isolation may extend beyond the inverter (224). The DC/DC clusters may be isolated from each other to allow the power system to completely disconnect form power sources that could be operating outside pre-determined engineering tolerances.

The inverter (224) may be connected to a battery (226). The battery (226) is one or more batteries that store or discharge electrical energy via the inverter (224). For example, dual batteries can be utilized. Each of the dual batteries may be connected to an isolated DC/DC converter and the inverter (224), thereby providing for an independent power system.

The battery (226) may be charged using the engine (204) (by utilizing regenerative braking), by a fast charger, or by another compatible haul truck system. The battery (226) also may be used to power other systems on the haul truck (200) to allow the haul truck (200) to operate without the engine (204) running.

The inverter (224) is connected to a power controller (228). The power controller (228) is electrical and mechanical components that control the distribution of electrical power to other electrical components of the haul truck (200). For example, the power controller (228) may control the amount of power generated by or used by the motor (222), and thus may control the amount of power applied to the drive shaft (216) via the motor (222). The power controller (228) also may control electrical power to other electrical components in the haul truck (200), such as the battery (226), or various other electrical systems.

The power controller (228) may be based on a programmable logic controller hardware platform. The platform may be used to control and monitor various functions and systems of the haul truck (200). Integrated security may be used to protect against unintended modification while still allowing flexibility in customization depending on customer specifications.

The power controller (228) may include a variety of components. The power controller (228) may include the programmable logic controller, communications modules and equipment, power supplies and power distribution equipment, diagnostics and data logging computing devices, radio equipment, etc.

The haul truck (200) also includes an interface (230), which may be connected (at least indirectly) to the power controller (228). The interface (230) includes a display (monitor, touchscreen, audio device, haptic device, etc.) for displaying information to a user. The interface (230) also includes one or more user devices (touchscreens, speakers, haptic devices, mice, keyboards, etc.) so that an operator may control various functions of the power controller (228).

One or more embodiments shown in FIG. 2 may be varied. The motor (222) position may be altered to couple to the engine (204) instead of to the torque converter (214). Alternatively, the motor (222) may be directly coupled to the transmission (218) instead of to the engine (204) or to the torque converter (214). In this latter case, the drive shaft (216) may be connected between the motor (222) and the torque converter (214).

Still other variations are possible. For example, multiple motors could be added to increase output power. One or more motors may be connected to some or all of the wheels of the haul truck (200). The battery (226) may be replaced with hydrogen fuel cells or a trolley system, or such alternative energy sources may be added to the haul truck (200) in addition to the battery (226). For example, one or more solar cells may be placed on the haul truck (200) to charge the battery (226) while the haul truck (200) is not in operation or while the engine (204) idles.

FIG. 3, FIG. 4, FIG. 5, and FIG. 6 show different views of the haul truck shown in FIG. 1, in accordance with one or more embodiments. Components described with respect to FIG. 2 are also shown in the examples of FIG. 3 through FIG. 6. Thus, in FIG. 3 through FIG. 6, reference numerals in common with FIG. 1 refer to similar components having similar descriptions. Likewise, in FIG. 3 through FIG. 6, reference numerals in common with FIG. 2 refer to similar components having similar descriptions. Similarly, in FIG. 3 through FIG. 6, any reference numerals used in one figure and then repeated in a subsequent figure refer to similar components having similar descriptions.

FIG. 3 shows the section of the haul truck (100) cut along line A-A (110) in FIG. 1. The bed (108) is shown for reference. The portion of the haul truck (100) that may be retrofitted to accommodate a motor (222) is shown in detail section “C” (300).

Thus, attention is turned to FIG. 4, which shows an expanded view of the detail section “C” (300) in FIG. 3. As can be seen, the engine (204) is directly connected to the torque converter (214). In turn, the motor (222) is directly connected to the torque converter (214), opposite the engine (204).

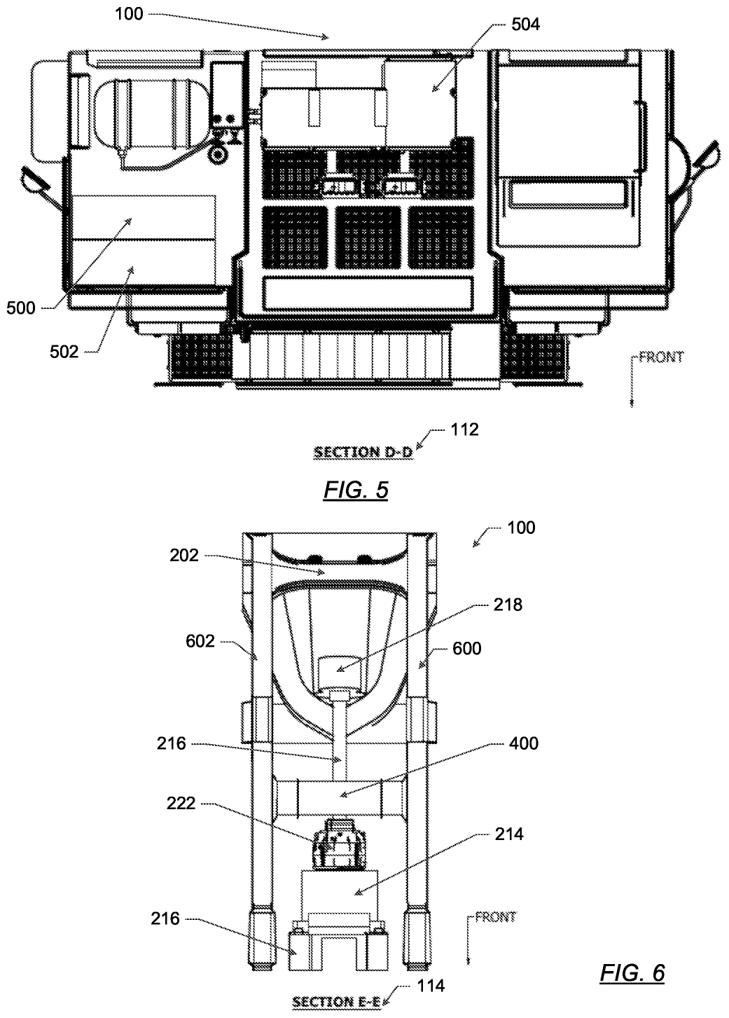

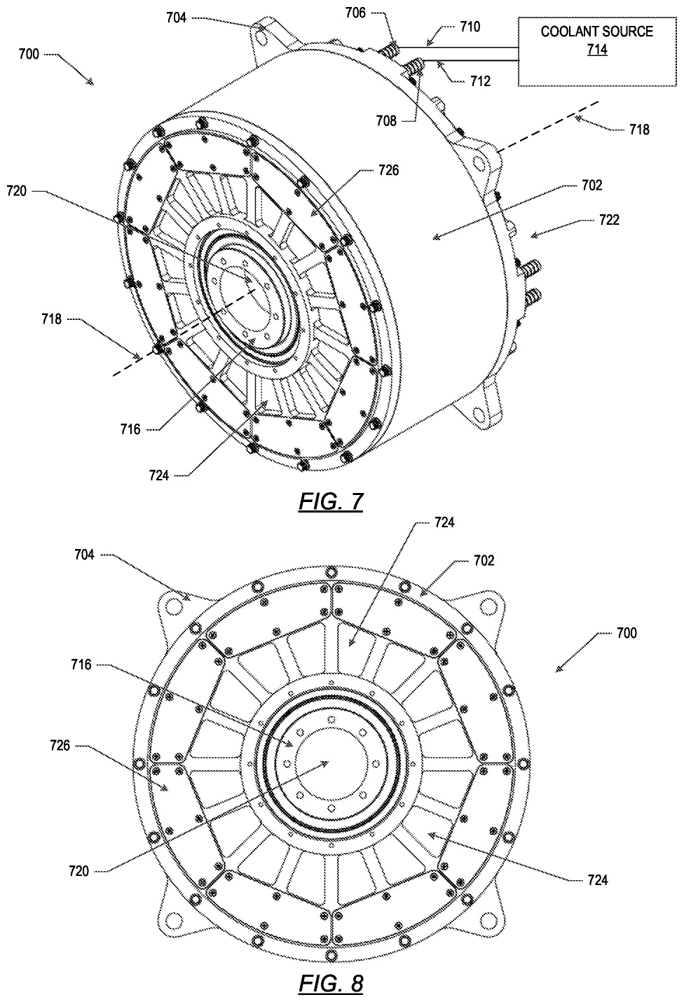

The drive shaft (216) is connected to the torque converter (214) through an annular shaft of the motor (222) (see FIG. 7 and FIG. 8). Alternatively, the drive shaft (216) is connected to one portion of the annular shaft of the motor (222), and the torque converter (214) is connected to an opposing portion of the annular shaft of the motor (222).

The position of the motor (222) may be varied. For example, the motor (222) may be connected directly to the transmission (218), in which case the drive shaft (216) may connect to the transmission (218) through the motor (222). Alternatively, the drive shaft (216) may connect to a first portion of the annular shaft of the motor (222). In this case, the transmission (218) may connect to an opposing portion of the annular shaft of the motor (222).

However, in one or more embodiments, directly connecting the motor (222) to the torque converter (214) or to the engine (204) may have additional utility. For example, the motor (222) may be higher up in the haul truck (100), relative to the ground. The motor (222) also may be more stable when directly connected to the heavier assembly of the engine (204) and the torque converter (214), relative to the transmission (218). The motor (222) also may be subject to fewer sheer forces when directly connected to the engine (204) or the torque converter (214).

The detail section “C” (300) shows other components of the haul truck (100) for reference. For example, an upper frame cross member (400) is disposed over the drive shaft (216), relative to a direction of gravity during normal operation of the haul truck (100). A lower frame cross member (402) is disposed under the drive shaft (216), relative to the direction of gravity during normal operation of the haul truck (100). A rear axle A-frame (404) is also shown for reference.

FIG. 5 shows a section of the haul truck (100) across line D-D (112). FIG. 5 shows the location of first battery (500) and second battery (502), which together may be the battery (226) shown in FIG. 2. FIG. 5 shows a drive cabinet (504) which contains parts of the power controller (228) shown in FIG. 2, including possibly the inverter (224).

FIG. 6 shows a section of the haul truck (100) across line E-E (114). In FIG. 6, the position of the engine (204), the torque converter (214), and the motor (222) may be seen. The position of the upper frame cross member (400) is also shown, along with beam (600) and beam (602) that form part of the chassis (202). Also visible are the drive shaft (216), and the transmission (218).

FIG. 7 and FIG. 8 show different views of a motor (700) installed in the haul truck of FIG. 2 or in the haul truck as shown in the views of FIG. 3, FIG. 4, and FIG. 6, in accordance with one or more embodiments. Thus, the motor (700) may be the motor (222) of FIG. 2 or of FIG. 3 through FIG. 6. FIG. 7 and FIG. 8 should be viewed together in the following description.

The motor (700) includes a stator frame (702) which serves as a housing for the motor (700). One or more mounting brackets, such as mounting bracket (704) are shown connected to the stator frame (702). The mounting brackets may be sized and dimensioned to permit direct connection of the motor (700) to the torque converter or the engine. For example, the mounting bracket (704) may be connected to the stator frame (702) at one end of the motor (700) such that the motor (700), when connected to the torque converter or engine, may be directly connected to torque converter or engine. However, the mounting bracket (704) also may be sized and dimensioned to permit the motor (700) to be directly attached to the torque converter or engine while still allowing some space between the motor (700) and the torque converter or engine.

The space may permit one or more coolant lines, such as a coolant supply line (706) and a coolant drain line (708), to be connected to the motor (700). The coolant supply line (706) and the coolant drain line (708) may be connected to coolant lines, such as coolant line (710), and coolant line (712). The coolant line (710) and the coolant line (712) are tubes or other fluid or gas communication channels that permit coolant to pass between the coolant supply line (706) or coolant drain line (708) and a coolant source (714).

The coolant source (714) is connected within the haul truck (e.g., to the chassis or as part of the power control system). The coolant source (714) stores the coolant. The coolant may be a liquid (e.g., water, antifreeze, or some other liquid) or a gas (e.g., air, a refrigerant gas, etc.)

In use, liquid coolant may be pumped from the coolant source (714), through the coolant line (710), and then into the motor (700) via the coolant supply line (706). The coolant is then circulated within or around the motor (700). For example, coolant lines within the motor (700) may permit the coolant to circulate within the motor (700) without the coolant touching internal motor components. The coolant is then returned via the coolant drain line (708) to the coolant line (712) and then back to the coolant source (714). Optionally, one or both of the coolant line (710) and coolant line (712) may be connected to an intervening radiator in order to increase heat dissipation from the coolant as the coolant exits the motor (700). In either case, circulation of the coolant within or around the motor (700) may aid in maintaining the motor (700) within a pre-determined range of temperatures for a selected engineering tolerance.

The motor (700) also includes a rotor (716). The rotor (716) may rotate about a longitudinal axis (718) of the motor (700). The rotor (716) may be connected to a drive shaft (e.g., the drive shaft (216) of FIG. 2). Thus, when the drive shaft is rotated by the engine, the drive shaft rotates the rotor (716). In turn, rotation of the rotor (716) turns electrically conductive windings within the motor (700) about a hollow magnetic cylinder disposed around the motor (700). The electrically conductive windings may be, for example, copper, though other electrically conductive materials may be used. The hollow magnetic cylinder may be, for example, iron, though other magnetic metals may be used.

As a result of turning the windings around the hollow magnetic cylinder, electricity may be generated by the motor or consumed by the motor depending on the direction of spin of the rotor (716). For example, electricity from a battery may be provided to the motor. As a result, the rotor (716) spins in one direction, causing the motor (700) to apply force to the rotor (716) (hence any drive shaft within the motor (700)) and thereby cause rotation of the drive shaft.

Alternatively, the engine may rotate the drive shaft and thereby rotate the rotor (716) in an opposing direction, causing the motor (700) to generate electricity. The generated electricity may be stored in the battery. In another alternative, the drive shaft may be decoupled from the engine while the vehicle is in motion. The motion of the wheels of the vehicle may then rotate the drive shaft, hence the rotor (716), to generate electricity within the motor (700). In this case, the motor (222) applies torque in an opposing direction of rotation of the motor (222), which in turn slows rotation of the drive shaft (216) and accordingly slows the haul truck.

An annular cavity (720) is disposed into or through the rotor (716) of the motor (700). The annular cavity (720) is sized and dimensioned to permit a drive shaft of the haul truck to be connected to the motor (700) within the annular cavity (720). The annular cavity (720) may be a through-and-through hole in the rotor (716), or may be a chamber within the rotor (716) that is open on at least one side of the motor (700).

In an embodiment, the torque converter or engine is directly connected to a first side (722) of the motor (700). In turn, the drive shaft extends out of the annular cavity (720) on a second side (724) of the motor (700). However, in another arrangement, the second side (724) of the motor (700) may be connected to a transmission of the haul truck, with the rotor (716) (possibly via a connection within the annular cavity (720)) connected to the transmission. In this case, the drive shaft may extend out of the annular cavity (720) on the second side (724) of the motor (700).

The motor (700) also may include a seal (726). The seal (726) may take the form of multiple plates, such as the plates shown in FIG. 7 and FIG. 8. However, the plates may be sized, dimensioned, and positioned differently than the arrangement of plates shown in FIG. 7 and FIG. 8. More or fewer plates may be present. The seal (726) also may take the form of a single piece of material that extends across one or both of the first side (722) and the second side (724). However, in the latter variation a hole in the seal (726) will be present to accommodate the annular cavity (720) so that a drive shaft or other component (torque converter, engine, or transmission) also may be connected to the motor (700).

The seal, in conjunction with the stator frame (702), prevents foreign object debris (dirt, fluids, rocks, sand, trash, etc.) from entering inside the motor (700). In this manner, the motor (700) may continue to operate in the harsh conditions imposed during operation of the haul truck. While the motor (700) may cool more slowly by thermal conduction because of the presence of the seal (726), the cooling system (composed of the coolant supply line (706), coolant drain line (708), coolant line (710), coolant line (712), and coolant source (714)) may keep the operating temperature of the motor (700) within desired engineering tolerances.

Various additional details of the motor (700) are now presented. The motor (700) may be, in one embodiment, a fully sealed liquid cooled motor with a diameter of 500 millimeters (mm) (relative to the longitudinal axis (718)) and a length of 250 mm (relative to the longitudinal axis (718)). The motor (700) may have a weight of 140 kilograms (kg) and have overall dimensions that fit in an area available next to the torque converter on the underside of the haul truck.

In a retrofit operation, this area is not intended for a motor. Thus, the diameter of the motor may be about equivalent to (or less than) the diameter of the transmission and/or torque converter cover plate. This area may be clear of hoses and auxiliary systems. The bolts used to secure the plate to the transmission and/or torque converter may be lengthened to allow the motor to directly couple to transmission and/or torque converter.

The motor diameter, at a peak torque of 4244 newton-meters (nm,) normally uses an 80 mm diameter drive shaft. However, the drive shaft handles the combined torque of the engine and motor. Thus, the drive shaft diameter may be up to 120 mm using high strength 4340 steel. This shaft is 25% of the diameter of the motor, hence the motor internal parts (windings, core, etc.) are designed to compensate for the lost electromagnetic area.

Part of the compensation is to increase the pole count to tens of poles (e.g., 40 poles) compared to four or eight poles normally used on standard motors to use a permanent magnet rotor, as opposed to induction rotors normally seen on haul truck motors. Furthermore, the motor (700) uses liquid cooling instead of air cooling normally seen on haul truck motors. Liquid cooling allows for a more compact and fully sealed motor for the harsh environment underneath the haul truck.

To allow the above-described power and dimensions, an exemplary motor (700) included a liquid cooled permanent magnet rotor with N52UH magnets and 40 poles. The motor (700) had an 800 kilowatt (KW) peak power output for more than 5 minutes to allow the maximum charging of batteries during downhill operation. The haul truck engine generally operates in a fixed speed range of 800 RPM to 1800 RPM. This RPM range means that that the motor produced a maximum torque in the same range that the engine produces maximum torque, at around 1800 RPM. Increasing the pole count (to 40 in this specific example) allowed the motor to produce the desired torque at those speeds without incurring large electrical losses that increase the temperature and decrease the lifespan of the permanent magnets. Increasing the pole count also meant that the power electronics controlling the motor operated at much higher frequencies than are normally used for these power levels on mining equipment. The power electronics of the power control system are designed to handle these frequencies with minimal losses.

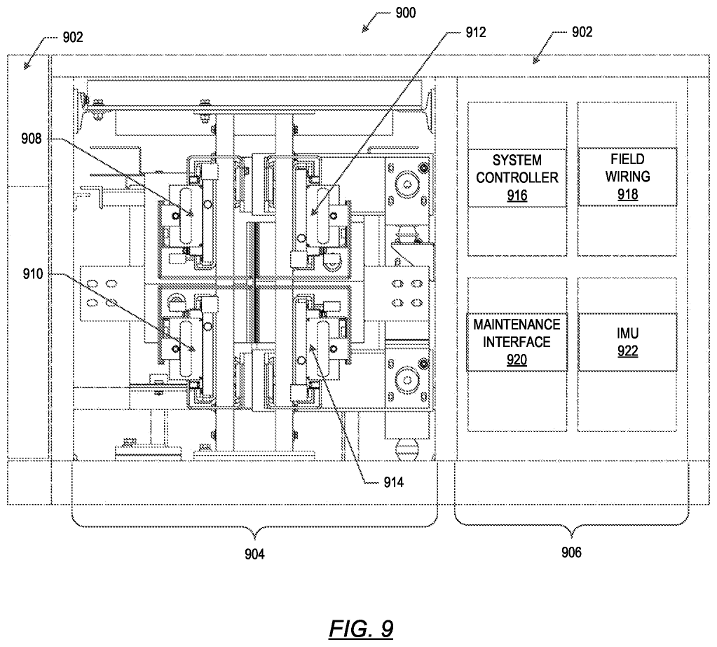

FIG. 9 shows a power cabinet for use in the hybrid haul truck shown in FIG. 2 through FIG. 6, in accordance with one or more embodiments. The power cabinet (900) disposed within a weldment (902) may be part of the power controller (228) shown in FIG. 2.

The power cabinet (900) includes two sections having components designed to perform one or more predetermined functions. Section A (904) includes drive electronics and a liquid cooling system that includes a fluid pump, as described above with respect to FIG. 7 and FIG. 8. Section A (902) also includes a number of fluid lines, as described with respect to FIG. 7 and FIG. 8. In turn, section B (906) is a control section of the power cabinet (900).

Section A (904) includes a number of modules that may be arranged together. The modules may be physically identical so that one module may be replaced with another, and so that the modules may be compactly arrayed within the section A (902). The modules may be provided with switches that change their functions. However, in the alternative, one or more of the modules may be different in order to accommodate different power control functionality.

In the example of FIG. 9, the Section A (904) includes a first inverter module (908), a second inverter module (910), and a third inverter module (912). Each inverter module is programmed by the switches (or is otherwise configured) to operate as an inverter, as described elsewhere herein. Together, the inverter modules in the Section B (904) may operate as a single inverter in the power controller (228) of FIG. 2. A fourth module, a DC/DC converter module (914), is programmed to convert DC electrical power from one voltage to another, different voltage.

More or fewer modules may be provided, and the modules may be programmed to perform different electrical functions. Each module may be easily accessed and serviced by opening a door to the power cabinet (900). The modules may utilize the same hardware for ease of replacement and spare part inventory. This high voltage portion of the power cabinet (900) may be locked to prevent unauthorized outside access.

Section B (906) includes a system controller (916) and field wiring (918), which also may be part of the power controller (228) shown in FIG. 2. The drive system cabinet provides ease of access and safety. High voltage areas are isolated and locked from access. Field wiring and electronics are behind hinged cabinet doors that can also be locked. A maintenance interface (920) may be available in the system controller section to allow access to data logging, trends, and system analytics.

The system controller in section C (906) may send commands to the drive system based on operator input, motor speed, motor temperature, engine communication, transmission communication, wheel speed, haul truck inclination, and/or internal measurement unit (IMU) units. The IMU (922) is a device that includes a combination of an accelerometer, a compass, and a gyroscope. Communication to the various system components may occur via J1939/Canbus, high speed ethernet, analog signals, or digital signals.

The system controller in Section B (906) may use one or more algorithms and the data described above to determine how and when to energize the motor to achieve reduced emissions and fuel usage while maximizing battery life. A maintenance interface may be available to allow access to data logging, trends, and system analytics. Wireless network connectivity may be included to allow remote monitoring, configuration, and cloud-based reporting for a fleet of haul trucks.

Section C (906) also my include auxiliary components, including an alternator field static exciter (AFSE), grid blower inverter, coolant pump, and high-power field terminals. Section C (906) also may include haul truck controls and haul truck sensor/instrument interfacing. The main programmable logic controller (PLC) rack, data logging, and all low voltage control fuses and relays are housed. A maintenance interface (920) (e.g., the interface (230) of FIG. 2) may be provided on the door of this cabinet section for onboard troubleshooting and data logging. The backside of the cabinet may be reserved for field connections and terminations.

While FIG. 1 through FIG. 9 may show a configuration of components, other configurations may be used without departing from the scope of one or more embodiments. For example, various components may be combined to create a single component. As another example, the functionality performed by a single component may be performed by two or more components.

The components described with respect to FIG. 1 through FIG. 9 may be arranged in different arrangements. The different arrangements provide for different haul truck configurations, each considered a variation of the haul truck examples shown in FIG. 1 through FIG. 9. In addition, while one or more embodiments are described as a haul truck, one or more embodiments also may be useful for manufacturing a hybrid vehicle or for retrofitting other types of vehicles that include a combustion engine.

Thus, one or more embodiments provide for a vehicle including a chassis, an engine connected to the chassis, and a torque converter directly connected to the engine. A motor having a first side and a second side is directly connected to the torque converter, opposite the engine. The motor further includes a rotor having an annular shaft cavity. The motor further has a first diameter equal to or smaller than a second diameter of the torque converter in order that the motor fits in an existing haul truck. The motor is connected to the torque converter via the annular shaft cavity. In addition to the above, the vehicle also includes a drive shaft directly connected to the motor, opposite the torque converter. The drive shaft is operatively disposed in the annular shaft cavity. The vehicle also includes a transmission connected to the drive shaft, a differential connected to the transmission, and a set of wheels connected to the differential.

In the above-described vehicle, the motor further may include a stator frame disposed around a circumference of the motor. In this case, the motor also includes a first side facing away from the torque converter and a second side facing the torque converter. The motor also includes a mounting bracket directly attached to the stator frame proximate the second side of the motor. The motor is connected to the torque converter via the mounting bracket.

In the above-described vehicle, the motor may include a first side facing away from the torque converter and a second side facing the torque converter. The motor further includes a seal connected to the first side of the motor. The seal at least partially prevents external access to windings connected to the rotor inside the motor.

In the above-described vehicle, the motor further may include a stator frame disposed around a circumference of the motor. The motor also may be characterized as having a first side facing away from the torque converter and a second side facing the torque converter. A gap may be defined between the motor and the torque converter. In this case, the motor also includes a fluid transmission line connected to the stator frame proximate the second side of the motor. The fluid transmission line is located at least partially within the gap. A fluid source may be connected to the fluid transition line and store a fluid. A cooling system may disposed inside the stator frame and disposed to distribute the fluid through the cooling system.

In the above-described vehicle, the vehicle also may include an inverter connected to the motor. A battery may be connected to the inverter.

As indicated throughout the specification, the vehicle may be a haul truck. Thus, for example, the chassis of the haul truck may include a pair of longitudinal frame members disposed between a front of the haul truck and a rear of the haul truck. The haul truck also may include a frame cross member disposed between the pair of longitudinal frame members. The motor may be entirely disposed forward of the frame cross member, relative to the front of the haul truck, and under the frame cross member, relative to a direction of gravity.

In the above-described vehicle, a power controller may be connected to the motor. The power controller may be configured to control power sourced or sunk by the motor. The power controller may further include a number of inverter modules connected to each other and configured to control a power level output by the motor.

In the above-described vehicle, the vehicle also may include a cabin connected to the chassis. A user interface may be disposed within the cabin. The user interface may be configured to permit monitoring and configuration of the motor or of an inverter connected to the motor. The user interface may be configured to control an inverter power output to the motor. For example, the user interface may be configured to permit monitoring and configurating the motor and inverter. This configuration could be to disable the hybrid system or to put the hybrid in different driving power modes, such as a higher speed mode instead of maximum fuel savings mode. The existing haul truck user interfaces such as the transmission shifter and pedals may be used to control the inverter power output to the motor.

In the above-described vehicle, the vehicle also may include a deck connected to the chassis and a power cabinet connected the deck. A drive electronics and liquid cooling system may be disposed within a first section of the power cabinet, wherein the liquid cooling system is further connected to the motor. A number of inverter modules may be connected to each other within a second section of the power cabinet. The inverter modules may be configured to control a power level output by the motor. A system controller and wiring module may be placed within a third section of the power cabinet. A maintenance interface may be connected to the system controller and wiring module. An access door may be connected to the system controller and wiring module and configured to grant access inside the system controller and wiring module. The second section may be adjacent the first section and the third section may be adjacent the second section.

In another variation, one or more embodiments contemplate a vehicle including a chassis, an engine connected to the chassis, a torque converter directly connected to the engine, and a drive shaft directly connected to the torque converter. A motor may be connected to the drive shaft, opposite the torque converter. The motor further includes a rotor having an annular shaft cavity. The motor further includes a first diameter equal to or smaller than a second diameter of the torque converter. The motor is connected to the drive shaft via the annular shaft cavity. A transmission is connected to the motor and a differential is connected to the transmission. A number of wheels may be connected to the differential.

Again, the above-described vehicle may be a haul truck. In this case, the chassis may include a pair of longitudinal frame members disposed between a front of the haul truck and a rear of the haul truck and a frame cross member disposed between the pair of longitudinal frame members. In this case, the motor may be entirely disposed rearward of the frame cross member, relative to the rear of the haul truck, and under the frame cross member, relative to a direction of gravity.

Still other variations are possible. Thus, the examples provided above do not limit other examples or arrangements of the components presented in FIG. 1 through FIG. 9.

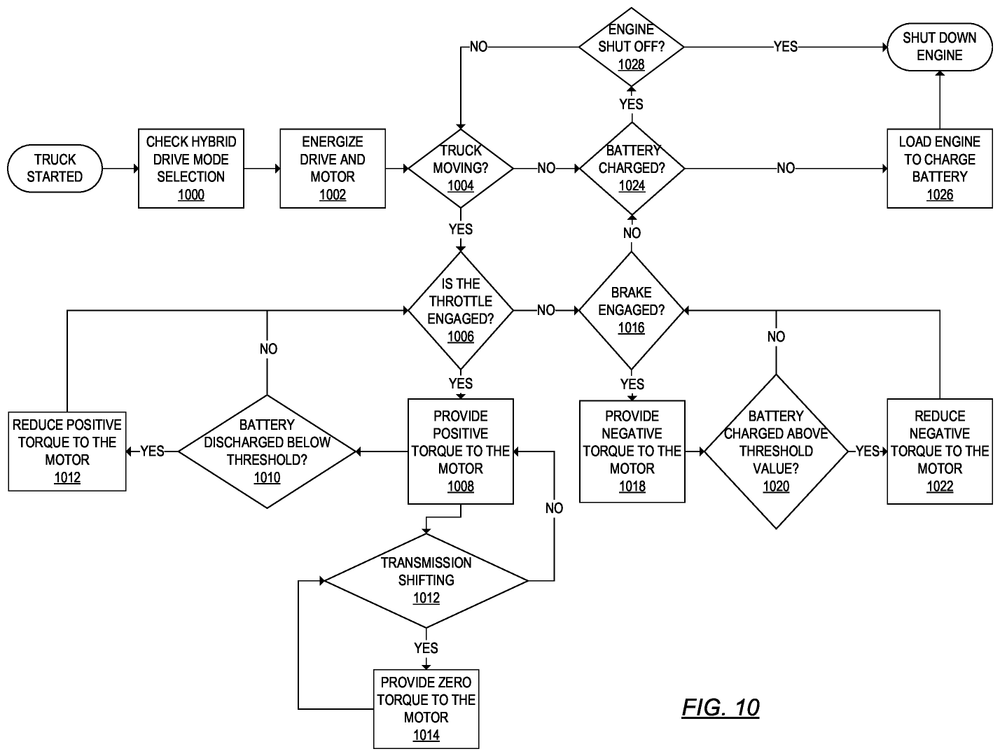

FIG. 10 shows a flowchart for power management while operating a hybrid haul truck, in accordance with one or more embodiments. The method of FIG. 10 may be executed using a hybrid haul truck, including a haul truck retrofitted with a hybrid system as described above. The term “system” as described below refers to the engine, torque converter, motor, drive shaft, power controller (e.g., the power controller (228) of FIG. 2), drive electronics, and other hardware and software components that permit power generation and distribution within the haul truck.

The method begins with the haul truck started. Step 1000 includes checking a hybrid drive mode selection. Specifically, the system verifies that the haul truck is operating in a hybrid drive mode.

Step 1002 includes energizing the drive and motor. Energizing the drive and the motor prepare the drive and motor to operate. Energizing may include closing or actuating one or more switches that allow power to flow from the battery to the inverter DC bus. The inverter then uses one or more switches to transform the DC power into AC power to control the motor.

Step 1004 includes determining whether the haul truck is moving. If the haul truck is moving (a “yes” determination at step 1004), then at step 1006 a determination is made whether the throttle is engaged. If the throttle is engaged (a “yes” determination at step 1006), then step 1008 includes providing a positive torque to the motor. Two paths then may be taken concurrently or sequentially after step 1008.

Along one path after step 1008, at step 1010 a determination is made whether the battery is discharged below a threshold energy level. If not (a “no” determination at step 1010), then the method returns to the decision at step 1006. If so (a “yes” determination at step 1010), then step 1012 includes reducing positive torque to the motor. The method then returns to the decision at step 1006.

Along a second path after step 1008, at step 1012 a determination is made whether the transmission is shifting. If the transmission is shifting (a “yes” determination at step 1012), then step 1014 includes providing zero torque to the motor. For example, the drive shaft may be disengaged from the torque converter or motor. Alternatively, the motor may be disengaged from the torque converter or motor. In either case, the method returns to step 1012 and continues to repeat. However, if the transmission is not shifting at step 1012 (a “no” determination at step 1012), then the method returns to step 1008 and positive torque is provided to the motor. In other words, monitoring for transmission shifting may be ongoing while positive torque is being provided to the motor, thereby causing positive torque to be applied to the motor.

Both the first path and the second path may repeat so long as the throttle is engaged at step 1006. However, if the throttle is not engaged (a “no” determination at step 1006), then the method proceeds to step 1016. Step 1016 includes determining whether the brake is engaged.

If the brake is engaged (a “yes” determination at step 1016), then at step 1018 the system provides negative torque to the motor. As a result, the rotor of the motor spins in an opposing direction relative to the direction of rotor spin at step 1008. The motor generates power, and the power generated may be transferred to the battery.

A determination is then made at step 1020 whether the battery is charged above a threshold value. If so (a “yes” determination at step 1020), then at step 1022 the system reduces the negative torque to the motor. As a result, less power is transferred to the battery. In an embodiment, the negative torque may be reduced to zero in order to prevent excess power from being transferred to the battery.

The method then returns to step 1016 in which a new determination is made whether the brake is engaged. Similarly, if at step 1020, the battery is not charged above the threshold value, then power generated by the motor is transferred to the battery, and subsequently the method once again returns to step 1016.

If the brake is not engaged (a “no” determination at step 1016), then at step 1024 a determination is made whether the battery is charged. The decision at step 1024 is also made if the haul truck is not moving (a “no” determination at step 1004). If the battery is not charged (a “no” determination at step 1024), then at step 1026 the engine is loaded to charge the battery. For example, the engine may be run to spin the motor (or to spin the drive shaft and thence the motor), but the drive shaft (or motor) may be disengaged from the transmission. As a result, the motor spins and generates electricity which is transmitted to the battery to charge the battery. Once the battery is charged, the engine may shut down and the process ends.

Note that step 1026 may be optional in some cases. For example, it may be determined that the engine may be shut down and the method terminated even if the battery is not charged at step 1024. Such an optional decision may be worthwhile when the haul truck is provided with solar panels which may charge the battery while the haul truck engine is not on.

Returning to step 1024, if the battery is charged (a “yes” determination at step 1024), then a determination is made at step 1028 whether the engine is to be shut off. If not, (a “no” determination at step 1028), then the method returns to the decision at step 1004 and the method proceeds from step 1004 as described above. If the engine is to be shut off (a “yes” determination at step 1028), then the engine is shut down, and the method terminates thereafter.

The method of FIG. 10 includes several useful aspects. For example, the method of FIG. 10 shuts the engine off when idling and not moving. This procedure reduces fuel consumption and greenhouse gas emissions because it is common for haul trucks to be idling 30% of the time or more during a typical work day.

In another example, the method of FIG. 10 provides for charging the battery during idle time. Motors on the output side of the transmission cannot charge the battery during idle time. Charge power can be optimized for speed or the least amount of fuel use. The battery may be charged while idling without at all increasing the fuel use of the haul truck over normal idling.

In another example, the method of FIG. 10 means retrofitting an existing haul truck may be easier. For example, the method of FIG. 10 may permit minimization of new equipment such as special modes or pedals for regenerating energy back into the battery.

In another example, the method of FIG. 10 provides for normal haul truck operation if the battery charge is low. Thus, the hybrid system haul truck permits the motor to be shut off and the haul truck permitted to operate as a normal combustion engine haul truck.

In another example, the method of FIG. 10 provides for additional braking power without putting additional wear on the brakes. For example, if the battery charge is low, then the motor may be engaged to generate power for the battery, with the motor being ultimately turned by the wheels. Torque produced by the motor in the opposite direction of rotation thereby forces the wheels to slow and hence slows the vehicle. However, if the battery charge is high, the system can cease regeneration (negative torque) and the haul truck still stops as the haul truck did before a retrofit.

In another example, the method of FIG. 10 provides for permitting the haul truck to move without the engine running. The motor alone may be used to force the wheels to move via the draft shaft, transmission, and differential when the motor is placed after the torque converter.

The method of FIG. 10 may be read as sub-methods that include different paths along the decision points of the method shown, using components described with respect to FIG. 2. For example, one or more embodiments provide for a method of operating a haul truck including an engine. The method includes energizing a drive system and the motor of a haul truck. The method also includes modifying, by a torque converter connected to the engine and directly connected to the motor, a torque applied by an engine to the torque converter to generate a modified torque. The method also includes applying, by the torque converter, the modified torque to the motor. The method also includes turning, by the modified torque, a rotor of the motor. The method also includes turning, with the rotor, a drive shaft connected to the rotor. The method also includes turning, with the drive shaft, a transmission of the haul truck. The method also includes turning, with the transmission, a differential of the haul truck. The method also includes propelling, with the differential, wheels of the haul truck.

The above-described method may be varied. For example, the above method may further include receiving a command to brake the haul truck. In the extended example, the method also may include commanding the torque converter to apply a negative torque to the motor to cause the rotor to turn in an opposite direction. Thus, power is generated when the rotor turns in the opposite direction. In the extended example, the method also may include routing the power to an inverter connected to the motor. In the extended example, the method also may include routing the power from the inverter to a battery connected to the inverter.

In another variation of the method of FIG. 10, the haul truck may include an inverter connected to the motor. In this case, an extended method further includes receiving a command to shift the transmission. The extended method also includes removing, by the inverter, torque from the motor while the transmission shifts. Removing may include the inverter commanding the motor to unlock from at least one of the torque converter, the drive shaft, and the transmission.

Other variations are possible. Thus, the examples above do not necessarily limit other embodiments.

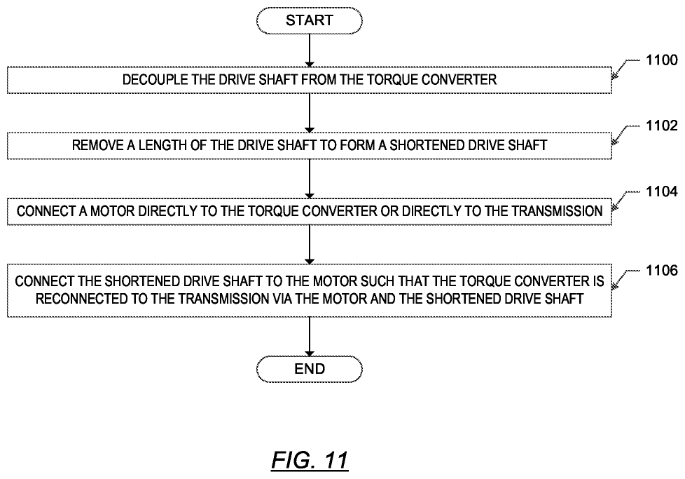

FIG. 11 shows a flowchart of a method for retrofitting a haul truck, in accordance with one or more embodiments. The method of FIG. 11 may be performed to retrofit an existing combustion engine haul truck to a hybrid haul truck, such as the haul truck examples shown in FIG. 2 through FIG. 9. Once retrofitted, the hybrid haul truck may be operated according to the method of FIG. 10. The method of FIG. 11 may be characterized as a method of retrofitting a haul truck including a chassis, an engine connected to the chassis, a torque converter connected to the engine, a drive shaft directly connected to the torque converter, a transmission directly connected to the drive shaft, a differential connected to the transmission, and wheels connected to the differential.

Step 1100 includes decoupling the drive shaft from the torque converter. Decoupling the drive shaft from the torque converter may be accomplished by pulling, cutting, or otherwise disengaging the drive shaft from the torque converter.

Step 1102 includes removing a length of the drive shaft to form a shortened drive shaft. The length of drive shaft may be removed by cutting through the drive shaft at a pre-determined position along the length of the drive shaft.

Step 1104 includes connecting a motor directly to the torque converter or directly to the transmission. The motor may be connected to the torque converter or transmission by way of mounting brackets, such as the mounting bracket (704) shown in FIG. 7 and FIG. 8. Bolts may extend through the mounting brackets and into the torque converter or transmission. Note that the bolts may be long enough, or corresponding mounting plates may be attached to the torque converter or transmission, such that a space may exist between the motor and the torque converter or the transmission. The existence of a space between the motor and the torque converter or transmission does not negate the fact that the motor is directly connected to the torque converter or transmission, because the bolts connecting the components are in touching relationship with respect to both the motor and the torque converter or transmission.

In an embodiment, the motor may be directly connected to the engine, in a manner similar to that described above with respect to the torque converter or transmission. Thus, step 1104 also contemplates the possibility that the motor is directly connected to the engine.

Step 1106 includes connecting the shortened drive shaft to the motor such that the torque converter is reconnected to the transmission via the motor and the shortened drive shaft. Thus, the drive shaft may still be present, extending from one end of the motor. The other end of the motor is connected to the torque converter (or engine) or to the transmission.

The method of FIG. 11 may be further varied. For example, the method also may include installing an inverter module connected to the chassis and to the motor. In this case, the method also may include connecting a battery to the inverter. Still other variations are possible, such as to change the chassis to accommodate the motor. Thus, the example of FIG. 11 is not necessarily limited to the examples provided above.

The method of FIG. 11, together with the components described with respect to FIG. 1 through FIG. 9 may be used to retrofit existing haul trucks of multiple other equipment manufacturer and size classes. Thus, one or more embodiments may reduce costs by retrofitting mechanical haul trucks while reducing overall emissions. The design of one or more embodiments may be used, for example, to retrofit the Caterpillar (CAT) 793 and CAT 777 haul trucks.

A specific example of retrofitting haul trucks, consistent with the method of FIG. 11, is now provided. The specific example provided below does not limit other embodiments or method of retrofitting combustion engine haul trucks into hybrid haul trucks.

A mine operator operates a fleet of fifty CATERPILLAR®, CAT 793® haul trucks. The mine has a greenhouse gas reduction initiative of 30% by 2030. CATERPILLAR® does not offer emission reduction systems for this generation mechanical diesel haul truck. The current solution would be to scrap the fifty CAT 793® haul trucks and purchase fifty new diesel electric haul trucks that offer an emission reduction system. The CAT 793® utilizes a 2500 horsepower (HP) diesel engine that can create 6700 foot-pounds (ft-lbs) of torque.

The space available for an electric assist motor is 20 inches in length. The profile of the mine requires at least 225 KW from the electric assist motor to meet the 30% emission reduction goal. Motors available from other vendors that fit in the desired space are not rated to handle the 6700 ft-lbs of engine torque plus the torque from the motor. Drives available from other vendors in this class are not suitable for the haul truck power level, do not include a system controller, and require modifications to safely operate in the space available. Supporting items such as a thermal management system are not included.

In contrast, the mechanical haul truck hybrid system motor in FIG. 7 and FIG. 8 is designed with high strength alloys to handle the engine torque plus motor torque with suitable engineering tolerance margin. The motor is mechanically designed to directly fit in the space available with only minor structural changes to the haul truck. The drive system is developed in conjunction with the motor to provide the power levels used during heavy use. The algorithms and hardware used to control the motor fit properly on the deck of the haul truck for quick access, and contain supporting thermal management. The algorithms and hardware also include the system controller functionality that determines how and when to energize the motor to achieve reduced emissions and fuel usage while maximizing battery life.

Thus, the mine operator can retrofit their existing fleet with the mechanical haul truck hybrid system and continue utilizing the investment made in purchasing the fleet. The resulting hybrid haul truck system also helps the mine operator meet emission reduction goals, when the only other alternative may be to scrap the fleet and purchase new haul trucks at a substantially greater cost.

While the various steps in the flowcharts of FIG. 10 and FIG. 11 are presented and described sequentially, at least some of the steps may be executed in different orders, may be combined or omitted, and some of the steps may be performed in parallel. Furthermore, the steps may be performed actively or passively.

One or more embodiments described herein have several benefits. For example, many haul trucks utilize autonomous driving systems. These systems may use a series of sensors and predefined routes to operate the haul trucks without drivers. Any changes to the way the haul truck operates may entail changes to the autonomous driving system. However, one or more embodiments permit the haul truck to continue to operate as before, but with a hybrid system. In other words, one or more embodiments permit retroactively adding the hybrid system to the haul truck without requiring any operational changes to the haul truck. Accordingly, the autonomous driving system may continue to function normally, as before the retrofit, without the need for any testing or recertification.

One or more embodiments are not similar to ordinary hybrid automobile vehicles. For example, the motor of one or more embodiments may have at least five times the power of an automotive system, operating at a lower RPM, leading to different motor designs and requirements to those described above. Additionally, haul truck transmissions and torque converters are different than passenger vehicles and very expensive. Most automotive hybrid systems are integrated in with the transmission, whereas when retrofitting a haul truck the transmission is kept separate from the hybrid systems (e.g., the motor). Adding a hybrid system to an existing haul truck without a replacement transmission or torque converter, as described above, is a cost effective way to retrofit a combustion engine haul truck to become a hybrid haul truck.

Another distinguishing fact that differentiates hybridizing haul trucks relative to hybrid systems for automobiles is that, in a haul truck, as the transmission shifts gears, the torque converter is unlocked to decouple the engine from the transmission. Unlocking the torque converter to decouple the engine from the transmission reduces wear and tear on the transmission clutches. Due to the placement of the motor, one or more embodiments (via the power controller (228) of FIG. 2) may detect the torque converter unlock and immediately remove torque from the driveshaft during shifting. This procedure does not occur with automotive hybrid systems that are integrated into the transmission.

In another haul truck hybrid retrofit procedure, the diesel engine driveshaft may be removed, and a high power density electric motor may be coupled to the engine torque converter output. The motor is described above, and is considered a “high power density” electric motor because of the number of poles present in the motor, as described above. The high power density motor acts as an extension of the driveshaft and thus handles the sum of the torque the motor produces and the torque the engine produces. Accordingly, a strong motor shaft is provided that uses high strength alloys (e.g., 4340 steel as described above) that are not found on other motors that fit in the space available.

The motor electrical design of one or more embodiments may be unique to fit in the allocated space and operate with the high strength shaft. A shorter driveshaft (relative to the original haul truck) may be placed on the opposite side of the electric motor that couples the electric motor to the transmission.

A battery and specialized drive system may be placed on the haul truck to power and control the motor. The drive system may be designed to interface to the battery, to the system controller, and to control the speed and torque of the motor. The drive system may operate in the dirty, high vibration, and extreme temperatures of a haul truck while providing maximum reliability and ease of service. The drive system thus may include the components used to provide a complete working drop-in solution for retrofitting haul trucks to hybrid technology.

A dedicated liquid cooling thermal management system and pump may be included in the drive to keep the power electronics, battery, and optionally the motor in a desired operating temperature range while allowing the system to be sealed from outside elements. A system controller is included to control power flow between the battery, engine, motor, and the drive system.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

In addition, the term “directly connected to” means that component A and component B are connected immediately adjacent to each other. For example, component A and component B may share a common point of contact in at least one area of both components. However, the common point of contact may be a connector (e.g., a bolt, a screw, etc.), in which case it is possible that component A is “directly connected to” component B without a direct contact between the surfaces of component A and component B. However, in any case, if component A and component B are “directly connected to” each other, then no intervening parts, other than possibly a connector, exist between component A and component B.

The figures show diagrams of embodiments that are in accordance with the disclosure. The embodiments of the figures may be combined and may include or be included within the features and embodiments described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the one or more embodiments. However, it will be apparent to one of ordinary skill in the art that one or more embodiments may be practiced without these specific details. In other instances, well-known features have not been described in detail to avoid unnecessarily complicating the description. Further, other embodiments not explicitly described above can be devised which do not depart from the scope of one or more embodiments as disclosed herein. Accordingly, the scope of one or more embodiments should be limited only by the attached claims.

What is claimed is:

1. A vehicle comprising:
a chassis;
an engine connected to the chassis;
a torque converter directly connected to the engine;
a motor having a first side and a second side directly connected to the torque converter, opposite the engine, wherein:
the motor further comprises a rotor having an annular shaft cavity,
the motor further comprises a first diameter equal to or smaller than a second diameter of the torque converter, and
the motor is connected to the torque converter via the annular shaft cavity,
a drive shaft directly connected to the motor, opposite the torque converter,
wherein the drive shaft is operatively disposed in the annular shaft cavity;
a transmission connected to drive shaft;
a differential connected to the transmission; and
a plurality of wheels connected to the differential.

2. The vehicle of claim 1, wherein:
the motor further comprises a stator frame disposed around the circumference of the motor,
the motor comprises a first side facing away from the torque converter and a second side facing the torque converter,
the motor comprises a mounting bracket directly attached to the stator frame proximate the second side of the motor, and
the motor is connected to the torque converter via the mounting bracket.

3. The vehicle of claim 1, wherein:
the motor comprises a first side facing away from the torque converter and a second side facing the torque converter,
the motor further comprises a seal connected to the first side of the motor, and
the seal at least partially prevents external access to a plurality of windings connected to the rotor inside the motor.

4. The vehicle of claim 1, wherein the motor further comprises a stator frame disposed around a circumference of the motor, wherein the motor comprises a first side facing away from the torque converter and a second side facing the torque converter, wherein a gap is defined between the motor and the torque converter, and wherein the vehicle further comprises:
a fluid transmission line connected to the stator frame proximate the second side of the motor, wherein the fluid transmission line is located at least partially within the gap;
a fluid source connected to the fluid transition line and storing a fluid; and
a cooling system disposed inside the stator frame and disposed to distribute the fluid through the cooling system.

5. The vehicle of claim 1, further comprising:
an inverter connected to the motor; and
a battery connected to the inverter.

6. The vehicle of claim 1, wherein the vehicle comprises a haul truck.

7. The vehicle of claim 6, wherein the chassis comprises:
a pair of longitudinal frame members disposed between a front of the haul truck and a rear of the haul truck;
a frame cross member disposed between the pair of longitudinal frame members; and
wherein the motor is entirely disposed forward of the frame cross member, relative to the front of the haul truck, and under the frame cross member, relative to a direction of gravity.

8. The vehicle of claim 1, further comprising:
a power controller connected to the motor, the power controller configured to control power sourced or sunk by the motor.

9. The vehicle of claim 8, wherein the power controller further comprises:
a plurality of inverter modules connected to each other and configured to control a power level output by the motor.

10. The vehicle of claim 1, further comprising:
a cabin connected to the chassis; and
a user interface disposed within the cabin, wherein:
the user interface is configured to permit monitoring and configuration of the motor or of an inverter connected to the motor, and
the user interface is configured to control an inverter power output to the motor.

11. The vehicle of claim 1, further comprising:
a deck connected to the chassis;
a power cabinet connected the deck; and
a drive electronics and liquid cooling system disposed within a first section of the power cabinet, wherein the liquid cooling system is further connected to the motor.

12. The vehicle of claim 11, further comprising:
a plurality of inverter modules connected to each other within a second section of the power cabinet, wherein the plurality of inverter modules are configured to control a power level output by the motor.

13. The vehicle of claim 12, further comprising:
a system controller and a wiring module within a third section of the power cabinet;
a maintenance interface connected to the system controller and the wiring module; and
an access door connected to the system controller and the wiring module and configured to grant access inside the system controller and the wiring module.

14. The vehicle of claim 13, wherein the second section is adjacent the first section and wherein the third section is adjacent the second section.

15. A vehicle comprising:
a chassis;
an engine connected to the chassis;
a torque converter directly connected to the engine;
a drive shaft directly connected to the torque converter;
a motor connected to the drive shaft, opposite the torque converter, wherein:
the motor further comprises a rotor having an annular shaft cavity,
the motor further comprises a first diameter equal to or smaller than a second diameter of the torque converter,
the motor is connected to the drive shaft via the annular shaft cavity, and
a transmission connected to motor;
a differential connected to the transmission; and
a plurality of wheels connected to the differential.

16. The vehicle of claim 15, wherein the vehicle comprises a haul truck.

17. The vehicle of claim 16, wherein the chassis comprises:
a pair of longitudinal frame members disposed between a front of the haul truck and a rear of the haul truck;
a frame cross member disposed between the pair of longitudinal frame members; and
wherein the motor is entirely disposed rearward of the frame cross member, relative to the rear of the haul truck, and under the frame cross member, relative to a direction of gravity.

18. A method of retrofitting a haul truck comprising a chassis, an engine connected to the chassis, a torque converter connected to the engine, a drive shaft directly connected to the torque converter, a transmission directly connected to the drive shaft, a differential connected to the transmission, and a plurality of wheels connected to the differential, the method comprising:
decoupling the drive shaft from the torque converter;
removing a length of the drive shaft to form a shortened drive shaft;
connecting a motor directly to the torque converter or directly to the transmission; and
connecting the shortened drive shaft to the motor such that the torque converter is reconnected to the transmission via the motor and the shortened drive shaft.

19. The method of claim 18, further comprising:
installing an inverter module connected to the chassis and to the motor; and
connecting a battery to an inverter.

20. The method of claim 18, further comprising:
installing a power cabinet disposed within a cabin of the haul truck;
installing a drive electronics and liquid cooling system disposed within a first section of the power cabinet, wherein the liquid cooling system is further connected to the motor,
installing a plurality of inverter modules connected to each other within a second section of the power cabinet, wherein the plurality of inverter modules are configured to control a power level output by the motor;
installing a system controller and wiring module within a third section of the power cabinet;
installing a maintenance interface connected to the system controller and a wiring module; and
installing an access door connected to the system controller and the wiring module and configured to grant access inside the system controller and the wiring module.

21. A method of operating a haul truck comprising an engine, the method comprising:
energizing a drive system and the motor of the haul truck;
modifying, by a torque converter connected to the engine and directly connected to the motor, a torque applied by an engine to the torque converter to generate a modified torque;
applying, by the torque converter, the modified torque to the motor;
turning, by the modified torque, a rotor of the motor;
turning, with the rotor, a drive shaft connected to the rotor;
turning, with the drive shaft, a transmission of the haul truck;
turning, with the transmission, a differential of the haul truck; and
propelling, with the differential, a plurality of wheels of the haul truck.

22. The method of claim 21, further comprising:
receiving a command to brake the haul truck;
commanding the torque converter to apply a negative torque to the motor to cause the rotor to turn in an opposite direction, wherein power is generated when the rotor turns in the opposite direction;
routing the power to an inverter connected to the motor; and
routing the power from the inverter to a battery connected to the inverter.

23. The method of claim 22, wherein the haul truck further comprises an inverter connected to the motor, and wherein the method further comprises:
receiving a command to shift the transmission; and
removing, by the inverter, torque from the motor while the transmission shifts, wherein removing comprises the inverter commanding the motor to unlock from at least one of the torque converter, the drive shaft, and the transmission.
